(19) United States
(12) Patent Application Publication
(10) Pub. No.: US 2005/0213140 A1
(43) Pub. Date: Sep. 29, 2005

(54) Network facsimile machine with improved usability

(76) Inventor: Osamu Suzuki, Kanagawa (JP)

Correspondence Address: Ivan S. Kavrukov, Esq.;Cooper & Dunham LLP, 1185 Avenue of the Americas, New York, NY, 10036, US

(21) Appl. No.: 10/633,976

(22) Filed: Aug. 4, 2003

(30) Foreign Application Priority Data
Aug. 5, 2002 (JP) NO. 2002-227339

(51) Int. Cl. G06F 15/163; H04N 1/00

(52) U.S. Cl. 358/1.15; 358/400

(57) ABSTRACT

A network facsimile machine includes: an image information scanner part scanning the image information of an original and outputting image data; a display part including a predetermined display unit; a part transmitting and receiving image data via a public network; a part transmitting and receiving mail data via a network; a subject name registration part registering one or a plurality of subject names insertable into an electronic mail message for transmitting the mail data; a subject name specification determination part determining whether one of the subject names is specified for the mail data to be transmitted; and a subject name specifying part automatically specifying one of the subject names registered in the subject name registration part as the transmission subject name of the mail data if the subject name specification determination part determines that none of the subject names is specified for the mail data.

### BACKGROUND OF THE INVENTION

1. Field of the Invention

The present invention generally relates to network facsimile machines, and more particularly to a network facsimile machine that can set the title of an electronic mail message at the time of transmitting data using an electronic mail system.

2. Description of the Related Art

Facsimile machines, which can transmit and receive image data such as characters and drawings, have been widely used and are familiar business machines. The conventional facsimile machines include network facsimile machines (hereinafter referred to as “facsimile machines”) having the function of transmitting and receiving the data of an electronic mail message (also referred to as an “e-mail”) via the Internet. Such data is hereinafter referred to as “mail data.”

Such conventional facsimile machines include, for instance, the facsimile machine disclosed in Japanese Laid-Open Patent Application No. 2000-341465. This facsimile machine stores at least one of the destination address and the transmission title of an e-mail as transmission history data. This facsimile machine also stores data input previously by an operator. When the operator inputs a desired destination address or transmission title, the desired destination address or transmission title can be selected from the transmission history data or the previously input data. As a result, the operability of the facsimile machine is improved.

According to this conventional facsimile machine, however, the operator is required to perform an input operation for specifying the transmission title, that is, the subject name of the e-mail (hereinafter simply referred to as a “subject name”) whenever inputting the destination address or the transmission title. Therefore, even if it is possible or sufficient to use the same subject name for every transmission, the operator is required to perform the input operation for specifying the subject name for each transmission, which poses a problem to the operator.

### SUMMARY OF THE INVENTION

Accordingly, it is a general object of the present invention to provide a facsimile machine in which the above-described disadvantage is eliminated.

A more specific object of the present invention is to provide a facsimile machine with a mail transmission and reception function, the facsimile machine being made easy to use by incorporating the function of automatically specifying the subject name.

The above objects of the present invention are achieved by a network facsimile machine including: an image information scanner part scanning image information of an original and outputting image data; a display part displaying information, the display part including a predetermined display unit; a part transmitting and receiving image data via a public network; a part transmitting and receiving mail data via a network; a subject name registration part registering one or a plurality of subject names insertable into an electronic mail message for transmitting the mail data; a subject name specification determination part determining whether one of the subject names is specified for the mail data to be transmitted; and a subject name specifying part automatically specifying one of the subject names registered in the subject name registration means as the transmission subject name of the mail data if the subject name specification determination part determines that none of the subject names is specified for the mail data.

According to the above-described network facsimile machine, the subject name can be automatically specified without the operator performing an operation for specifying the subject name. Therefore, the network facsimile machine is easy to use.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a communication network for data communication using facsimile machines according to the present invention;

FIG. 2 is a block diagram showing the facsimile machine according to the present invention; and

FIGS. 3A and 3B are flowcharts showing a procedure for a subject name determination operation performed by the facsimile machine according to the present invention.

### DETAILED DESCRIPTION OF THE PREFERRED EMBODIMENTS

A description is given below, with reference to the accompanying drawings, of an embodiment of the present invention.

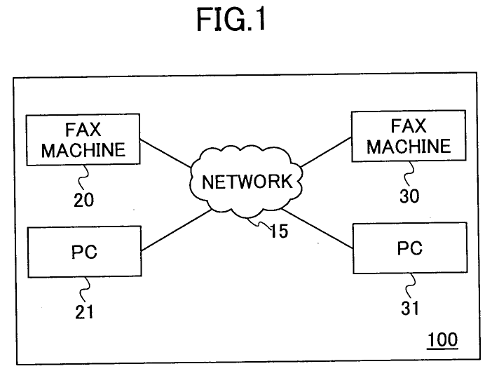

FIG. 1 is a diagram showing a communication network 100 for data communication using facsimile machines 20 and 30 according to the present invention. In FIG. 1, the communication network 100 includes the facsimile (FAX) machines 20 and 30 and personal computers (PCs) 21 and 31 that are connected via a network 15 such as the Internet. In the communication network 100, mail data is transmitted from the facsimile machine 20 or the PC 21 and received by the facsimile machine 30. The PC 31 can also be a destination to which the mail data is transmitted.

When the facsimile machine 20 or the PC 21 transmits an e-mail, its mail data is transmitted via the network 15 to be received by the facsimile machine 30. The facsimile machine 30 prints out the received mail data on a predetermined sheet of paper. The e-mail transmitted and received via the communication network 100 is composed mainly of document information transmitted as a message. Information such as image information or voice information is attached to the document information as an attachment file. While being transmitted through the network 15, the e-mail has the document information as well as the attached information such as image or voice information converted into a text format. In the following description, the facsimile machine 20 is taken as an example of the facsimile machine according to the present invention.

Next, a description is given, with reference to FIG. 2, of the basic internal configuration of the facsimile machine 20. FIG. 2 is a block diagram showing the facsimile machine 20. Referring to FIG. 2, the facsimile machine 20 includes a central processing unit (CPU) 1, a read-only memory (ROM) 2, a random access memory (RAM) 3, an operation display 4, an image information scanner 5, an image information output 6 such as a plotter, a coder-decoder (CODEC) 7, an image information storage 8, a modem 9, a PSTN (public switched telephone network) controller 10, and a LAN controller 11, which are connected to a data bus 12.

The CPU 1, which controls the operation of the entire facsimile machine 20 in accordance with a program stored in the ROM 2, operates as various means characterizing the present invention.

The ROM 2 is read-only storage means for storing the basic program for the facsimile machine 20 executed by the CPU 1, programs for realizing the functions characterizing the present invention, a communication control procedure, a network control procedure, a mail data transfer procedure, and permanent data. The RAM 3, which is used as the data region of the programs, operates as subject name registration means for registering the subject name for each of below-described user codes.

The operation display 4, which includes operation keys composed of mechanical or touch-panel keys having predetermined alphanumeric keys, is operation input means for exchanging data with the CPU 1 via the data bus 12. The operation display 4 inputs information necessary for using the facsimile machine 20 to the CPU 1 by the operation of the operation keys. Such information includes: operations necessary for the facsimile transmission of image data or the transmission of mail data, such as the inputting of the facsimile number of a transmission destination, start and stop operations, the setting of the subject name, and the inputting of the mail address of a transmission destination; and the confirming of transmission and reception status. The operation keys include: numeric keys for inputting facsimile numbers; start, stop, redial, and one-touch keys used in a series of operations performed at the time of facsimile transmission; and speed dial keys for selecting abbreviated numbers.

Further, the operation display 4 also serves as display means including: an LED display unit; a display unit such as a liquid crystal display (LCD) for displaying the subject name and the mail address of a transmission destination input through the operation keys, the current operating state, and time; and a sounding device such as a buzzer. The operation display 4 operates in response to an instruction input from the CPU 1.

The image information scanner 5 is image information scanning means for inputting image data by scanning, by an image sensor, the image of an original that is a paper sheet on which characters and drawings are formed, and converting the scanned image into an electrical signal. The image information scanner 5, which is also referred to as a scanner part, may be an image scanner using a charge-coupled device (CCD).

The image information output 6 is writing means including a mechanism for forming and printing an image on a paper sheet based on input image information representing received image and mail data, and the reception results (for instance, information such as the facsimile number of a transmitter and time of reception). The image information output 6 may be of any type that allows image recording on a paper sheet, such as an electrophotographic, ink-jet, or toner-jet type.

The CODEC 7 encodes and decodes input image data. The CODEC 7 also compresses the input image data, and stores the compressed image data in the image information storage 8. Further, the CODEC 7 decompresses the compressed input image data, and inputs the decompressed image data to the image information output 6 as raw data.

The image information storage 8 is image information storage means for storing image data read from an original to be transmitted and received image and mail data. The image information storage 8 is adapted to store the image data at least temporarily, and stores as files a plurality of received message data items and message data items to be transmitted. For instance, a magnetic disk unit is employed as the image information storage 8. The modem 9 performs modulation and demodulation necessary for the transmission and reception of image or mail data.

The PSTN controller 10, receiving an instruction from the CPU 1, controls a network control unit (NCU) (not shown in the drawing) to establish connection with a subscriber line PSTN and control communications with a communication terminal at the other end during the facsimile transmission and reception of image data. Further, the PSTN controller 10 operates the modem 9 to demodulate the received (modulated) data from the communication terminal at the other end and to modulate data to be transmitted. The PSTN controller 10 also detects the pulses of the ringing voltage detected in the NCU, a DTMF (dual tone multi-frequency) signal, and a tone signal, and sets up a call at the time of transmission.

The LAN controller 11, which transmits and receives mail data via the network 15, is network control means composed of an LSI that decodes received data, encodes data to be transmitted to the network 15, and performs buffering of a frame to be transmitted or a received frame.

Next, a description is specifically given, with reference to FIGS. 2, 3A and 3B, of functions of the facsimile machine 20 having the above-described configuration.

In the facsimile machine 20, the CPU 1 reads a predetermined program stored in the ROM 2 and operates each component, thereby realizing various functions characterizing the present invention. FIGS. 3A and 3B are flowcharts showing a procedure for an operation of determining the subject name, which operation characterizes the facsimile machine 20. This operation is referred to as a “subject name determination operation.”

While performing the subject name determination operation shown in FIGS. 3A and 3B, the facsimile machine 20 causes the CPU 1 to operate the image information scanner 5 so as to read the image information of a set original and create mail data to which the read image data is attached as an attachment file. The operator performs various operations for specifying the address of the facsimile machine 30 or the PC 31 to which the mail data is to be transmitted, and starts a transmission operation by pressing down the start key. Then, the CPU 1 of the facsimile machine 20 starts the subject name determination operation for the created mail data in accordance with the program stored in the ROM 2.

Once the subject name determination operation is started, in step S1 of FIG. 3A, the CPU 1 operates as subject name determination means to determine whether the operator has specified the subject name for the mail data in the previously performed various operations. If the CPU 1 determines in step S1 that the operator has specified the subject name, the CPU 1 terminates the subject name determination operation, and the subject name specified in the previously performed various operations is inserted in the mail data.

If the CPU 1 determines in step S1 that the subject name has not been specified, in step S2, the CPU 1 operates as identification code determination means to determine whether a user code has been specified. The user code is an identification code characteristic of the user (operator). The user code is used to manage a communication history from the specifying of the user code when the operator specifies the user code at the time of transmitting mail data. For instance, the user code is used to determine the number of communications (transmissions) performed by each operator. It is possible to register a plurality of subject names for each user code and determine which one of the registered subject names to use as a below-described transmission subject name. It is also possible to register a plurality of subject names that are common to the user codes and determine which one of the registered subject names to use. That is, it is possible to register a subject name specified for preferential use so that the specified subject name can be used as the transmission subject name. Further, it is also possible to register a name for each user code. Furthermore, if the user code is specified as an F code by a transmitter at the other end at the time of transmitting mail data, it is also possible to register for the user code a distribution destination to which the mail data is distributed. The user code, together with the above-described information, is stored in the RAM 3. The operator can select a subject name to be specified for preferential use from the registered subject names by operating the operation display 4.

If the CPU 1 determines in step S2 that the user code has been specified, in step S3, the CPU 1 operates as registration determination means to determine whether one or more subject names have been registered for the specified user code. If one or more subject names have been registered, the operation proceeds to step S4, and if not, the operation proceeds to step S5. In step S4, the CPU 1 operates as subject name specifying means to perform an operation for employing one of the registered subject names as a subject name at the time of mail transmission. The subject name employed at the time of mail transmission is referred to as the “transmission subject name.” For instance, in step S4, the CPU 1 may employ the first one of the registered subject names as the transmission subject name in a default state. Thereafter, the operation proceeds to step S19.

Thus, the facsimile machine 20 automatically specifies one of the previously registered subject names as the transmission subject name if no subject name is specified at the time of transmitting mail data. Therefore, for instance, if the same subject name such as “Circular Document” or “Weekly Report” is employable for every mail transmission, the facsimile machine 20 does not have to repeat an input operation for specifying the same subject name every time mail transmission is performed. This makes the facsimile machine 20 easy to use.

On the other hand, in step S5, the CPU 1 determines which subject name to use in correspondence to the user code. That is, the CPU 1 determines whether there has been a subject name specified for preferential use. If there has been a subject name specified for preferential use, the operation proceeds to step S6, and if not, the operation proceeds to step S8. In step S6, the CPU 1 determines whether the subject name specified for preferential use has been registered. If the subject name specified for preferential use has been registered, the operation proceeds to step S7, and if not, the operation proceeds to step S8. In step S7, the CPU 1 performs an operation for employing the registered specified subject name as the transmission subject name. Then, the operation proceeds to step S19.

Thus, the facsimile machine 20 allows the operator to previously select the subject name to be automatically employed from the registered subject names with respect to each user code. The facsimile machine 20 also allows the operator to specify the priority of each subject name to be automatically employed. This provides the operator with more latitude in operating the facsimile machine 20, thus making the facsimile machine 20 easy to use. The subject name to be automatically employed can be registered so as to correspond to the user code. Therefore, the facsimile machine 20 allows a plurality of operators to freely use the respective subject names corresponding to their user codes independent of one another. This also makes the facsimile machine 20 easy to use.

The operation proceeds to step S8 in any of the following cases: (a) the user code has not been specified, (b) no subject name has been registered and no subject name has been specified for preferential use although the user code has been specified, and (c) a subject name has been specified for preferential use but has not been registered. In any of these cases, in step S8, the CPU 1 performs an operation of retrieving a subject name to be employed as the transmission subject name from a plurality of subject names previously registered or stored in the facsimile machine 20. This retrieving operation may be performed by determining the first (leading) one of the subject names as the subject name to be employed, or by the operator previously determining what number subject name is to be employed and determining the subject name corresponding to that number as the subject name to be employed. Alternatively, the operator may previously determine the priorities of subject names to be employed, search the registered subject names in accordance with the priorities, and determine the first retrieved one of the registered subject names as the subject name to be employed.

After performing the retrieving operation in step S8, the operation proceeds to step S9, where the CPU 1 determines whether the subject name to be employed has been retrieved. If an employable subject name, that is, the subject name to be employed, has been retrieved, in step S10, the CPU 1 performs an operation for employing the subject name to be employed as the transmission subject name. Thereafter, the operation proceeds to step S19. If the subject name to be employed has not been retrieved, the operation proceeds to step S11 of FIG. 3B, where the CPU 1 again determines whether the user code has been specified. If the user code has been specified, the operation proceeds to step S12, and if not, the operation proceeds to step S16. In step S12, the CPU 1 operates as address registration determination means to determine whether the specified user code has a corresponding mail address registered as a distribution destination. If the specified user code has a corresponding mail address registered, the operation proceeds to step S13, where the CPU 1 performs an operation for creating a subject name using the registered mail address, and employing the created subject name as the transmission subject name. Thereafter, the operation proceeds to step S19 of FIG. 3A. The subject name created using the registered mail address may be one such as “From (the mail address of the distribution destination).”

On the other hand, if the CPU 1 determines in step S12 that the specified user code has no corresponding mail address registered as a distribution destination, the operation proceeds to step S14, where the CPU 1 operates as name registration determination means to determine whether the specified user code has a corresponding name registered. If the specified user code has a corresponding name registered, the operation proceeds to step S15, and if not, the operation proceeds to step S16. In step S15, the CPU 1 performs an operation for creating a subject name using the registered user code name, and employing the created subject name as the transmission subject name. Thereafter, the operation proceeds to step S19 of FIG. 3A. The subject name created using the user code name may be one such as “From (the user code name).”

The operation proceeds to step S16 if (a) the user code name has not been registered or (b) the subject name to be employed has not been determined from among the previously registered (stored) subject names and the user code has not been specified, either. In step S16, the CPU 1 determines whether transmitter information such as the facsimile number or the name of the transmitter has been registered. If the transmitter information has been registered, the operation proceeds to step S17, and if not, the operation proceeds to step S18. In step S17, the CPU 1 performs an operation for creating a subject name using the registered transmitter information, and employing the created subject name as the transmission subject name. The subject name created using the transmitter information may be as follows. If both facsimile number and name of the transmitter are registered, the subject name is “From (the facsimile number or the name of the transmitter).” If only the facsimile number of the transmitter is registered, the subject name is “From (the facsimile number of the transmitter).” If only the name of the transmitter is registered, the subject name is “From (the name of the transmitter).” If no transmitter information has been registered, in step S18, the CPU 1 performs an operation for creating a subject name where no registered information is used, such as “Fax Message,” and employing the created subject name as the transmission subject name. Then, the operation proceeds to step S19 of FIG. 3A.

Thus, if the subject name to be employed is not determined after searching the registered or stored subject names, the facsimile machine 20 can create the subject name using the mail address of a distribution destination registered in correspondence to the user code. Accordingly, even if there is no particular need to specify the subject name, the receiver can identify the transmitter of the mail by its subject name including the mail address of the transmitter. Even if no mail address is registered, it is possible to create the subject name using the user code name registered in correspondence to the user code. Therefore, the receiver can identify the transmitter of the mail by its subject name including the user code name of the transmitter. In this case, compared with the case of the subject name including the mail address, in which name information is not necessarily included, the transmitter can be identified more easily, thereby increasing convenience.

By the above-described operation, the facsimile machine 20 automatically determines the transmission subject name without the operator specifying the subject name. After the transmission subject name is determined, the operation proceeds to step S19, where the CPU 1 displays the transmission subject name determined through the previous steps on the operation display 4. This allows the operator to confirm the contents of the transmission subject name. Then, the operator determines the appropriateness of the contents of the transmission subject name. As a result of the determination, the operator determines the necessity of editing (correcting) the transmission subject name, and the operator inputs information showing the necessity of the editing or correction by operating the operation display 4. Receiving the input information, the CPU 1 causes the operation to proceed to step S20, where the CPU 1 determines whether the editing of the transmission subject name has been requested. If the editing has been requested, in step S21, the CPU 1 edits the transmission subject name according to the input operation by the operation display 4. If the editing has not been requested, the CPU 1 terminates the operation without performing step S21. Accordingly, the contents of the transmission subject name finally obtained reflect the results of the editing by the operator.

According to the present invention, the subject name can be specified by any of the following operations. First, the subject name can be newly input from scratch and be specified. This is suitable for the case of changing the subject name of mail data in every transmission. Second, one of previously registered subject names may be cited and employed as such. Third, one of the subject names previously registered (stored) in the RAM 3 may be cited, and edited as required to be employed as the subject name. This method is used in the case of creating a partially fixed subject name such as “Monthly Report (2001/11/30)” or “Daily Report (2001/12/01).”

Thus, if the subject name is not specified at the time of starting a transmission operation and is automatically determined, the facsimile machine 20 displays the determined subject name after the start key for starting transmission is pressed. Accordingly, the operator can check the subject name to be employed as the transmission subject name, which is convenient for the operator. Further, the subject name is editable as required. Therefore, even if the contents of the subject name are not as desired due to wrong input, it is possible to re-specify the subject name. This is also a convenient feature of the facsimile machine 20 for the operator.

Furthermore, it is possible to cite one of a plurality of previously stored subject names and edit the cited subject name. Therefore, even if the contents of the subject name are partially the same in every transmission, such as “Circular Document (2001/12/01)” or “Weekly Report (2001/12/07), the subject name can be input with minimum required editing. This makes the facsimile machine 20 easy to use.

As previously described, the network facsimile machine according to the present invention automatically specifies the subject name without the operator performing an operation for specifying the subject name. Therefore, this network facsimile machine is easy to use.

The present invention is not limited to the specifically disclosed embodiment, and variations and modifications may be made without departing from the scope of the present invention.

The present application is based on Japanese priority application No. 2002-227339, filed on Aug. 5, 2002, the entire contents of which are hereby incorporated by reference.

1. A network facsimile machine, comprising:
image information scanner means for scanning image information of an original and outputting image data;
display means for displaying information, the display means including a predetermined display unit;
means for transmitting and receiving image data via a public network;
means for transmitting and receiving mail data via a network;
subject name registration means for registering one or a plurality of subject names insertable into an electronic mail message for transmitting the mail data;
subject name specification determination means for determining whether one of the subject names is specified for the mail data to be transmitted; and
subject name specifying means for automatically specifying one of the subject names registered in said subject name registration means as a transmission subject name of the mail data if said subject name specification determination means determines that none of the subject names is specified for the mail data.

2. The network facsimile machine as claimed in claim 1, wherein said subject name specifying means specifies a specific one of the subject names registered in said subject name registration means as the transmission subject name.

3. The network facsimile machine as claimed in claim 1, further comprising means for causing one of the subject names registered in said subject name registration means to be specified as the transmission subject name.

4. The network facsimile machine as claimed in claim 1, wherein said subject name specifying means successively specifies the subject names registered in said subject name registration means as the transmission subject name in accordance with specified priorities of the registered subject names.

5. The network facsimile machine as claimed in claim 1, wherein said subject name registration means is adapted to be able to register the subject name by an identification code, the identification code being characteristic of an individual user.

6. The network facsimile machine as claimed in claim 5, further comprising:
code specification determination means for determining whether the identification code is specified; and
subject name registration determination means for determining whether the subject names are registered for the identification code determined by said code specification determination means to be specified,
wherein said subject name specification means employ, as the transmission subject name, one of the subject names determined by said subject name registration determination means to be registered.

7. The network facsimile machine as claimed in claim 6, further comprising address registration determination means for determining whether a mail address is registered for the identification code as an address to which the mail data is transmitted,
wherein said subject name specifying means specifies the mail address registered for the identification code as the transmission subject name when the subject name specification determination means determines that the subject names are not registered for the mail data, said code specification determination means determines that the identification code is specified, and said address registration determination means determines that the mail address is registered for the identification code.

8. The network facsimile machine as claimed in claim 7, further comprising user code name registration determination means for determining whether a user code name is registered for the identification code as an address to which the mail data is transmitted,
wherein said subject name specifying means specifies the user code name registered for the identification code as the transmission subject name when the subject name specification determination means determines that the subject names are not registered for the mail data, said code specification determination means determines that the identification code is specified, and said user code name registration determination means determines that the user code name is registered for the identification code.

9. The network facsimile machine as claimed in claim 8, wherein said subject name specifying means specifies the transmission subject name using one of a facsimile number and a name of a transmitter of the mail data.

10. The network facsimile machine as claimed in claim 9, wherein said subject name specifying means specifies the transmission subject name using one of: in the order described, the subject name; the mail address; the user code name; and the facsimile number or the name of the transmitter of the mail data registered for the identification code.

11. The network facsimile machine as claimed in claim 1, further comprising means for displaying the one of the subject names specified by said subject name specifying means on said display means.

12. The network facsimile machine as claimed in claim 11, further comprising editing means for editing, by an input operation, the one of the subject names displayed on said display means.

13. The network facsimile machine as claimed in claim 12, wherein said editing means is adapted to be able to perform editing using the subject names registered in said subject name registration means.
